(19) United States
(12) Patent Application Publication
(10) Pub. No.: US 2026/0339282 A1
(43) Pub. Date: Oct. 29, 2026

(54) NONLINEAR COMPENSATION CONTROL METHOD FOR PIEZOELECTRIC SYSTEM BASED ON MRAC-PID COMPOSITE CONTROL

(71) Applicant: North University of China, Taiyuan City (CN)

(72) Inventors: Xue QI, Taiyuan City (CN); Lina ZHANG, Taiyuan City (CN); Lei FAN, Taiyuan City (CN); Qiulin TAN, Taiyuan City (CN)

(73) Assignee: North University of China, Taiyuan City (CN)

(21) Appl. No.: 19/432,552

(22) Filed: Dec. 24, 2025

(30) Foreign Application Priority Data
Apr. 27, 2025 (CN) 202510534375.4

(51) Int. Cl. G05B 13/04

(52) U.S. Cl. CPC G05B 13/041; G05B 2219/42004; G05B 2219/42162

(57) ABSTRACT

A nonlinear compensation control method for a piezoelectric system based on MRAC-PID composite control relates to a piezoelectric system nonlinear compensation control method. To resolve problems that in the conventional technology, robustness is poor when complex nonlinearity and parameter mutation of the piezoelectric system are processed, and an ability to eliminate steady-state errors is weak when the piezoelectric system is independently used. The method includes the following steps: step 1, establishing a dynamics model of the piezoelectric system; and step 2, designing an MRAC-PID algorithm. The nonlinear compensation control method belongs to the technical field of piezoelectric system nonlinear compensation control.

### CROSS REFERENCE TO RELATED APPLICATION

This patent application claims the benefit and priority of Chinese Patent Application No. 202510534375.4, filed with the China National Intellectual Property Administration on Apr. 27, 2025, the disclosure of which is incorporated by reference herein in its entirety as part of the present application.

### TECHNICAL FIELD

The present disclosure relates to a nonlinear compensation control method for a piezoelectric system, and belongs to the technical field of piezoelectric system nonlinear compensation control.

### BACKGROUND

Piezoelectric systems are widely used in fields including precision positioning, actuation, and the like. In lithography equipment for semiconductor manufacturing, the piezoelectric system is configured to achieve high-precision stage positioning, and serves as a micro-actuator in a micro-electro-mechanical system (MEMS) to drive a motion of a microscopic structure. However, nonlinear characteristics of piezoelectric materials pose significant challenges to precise control of the piezoelectric systems.

It is usually difficult for a piezoelectric system based on a traditional control algorithm to accurately achieve various predefined performance metrics in practical operation. Due to inherent nonlinearities including hysteresis, creep, and the like in piezoelectric materials as well as interferences from complex and variable working environments, the piezoelectric system controlled by the conventional algorithm is prone to problems like reduced control precision and sluggish response, failing to meet practical application requirements of the piezoelectric system. For example, it is difficult for the traditional PID control to resolve the nonlinear problems in the piezoelectric system. The hysteresis in piezoelectric materials complicates an input-output relationship, leading to decreased response speed and compromised control accuracy when system parameters vary or external interferences occur, and ultimately failing to meet high-precision control requirements. Although parameters can be adjusted through model reference adaptive control (MRAC) based on a reference model, robustness is poor during processing of complex nonlinearities and abrupt parameter changes in the piezoelectric system, and a capability in eliminating steady-state errors is poor during standalone use.

The patent with a publication number of CN107544241B, filed on Sep. 25, 2017, discloses a nonlinear PID inverse compensation control method for hysteresis in a piezoelectric ceramic actuator. A Preisach hysteresis inverse model is established by using a numerical method and the established model is used to perform cascade compensation. Then, to enhance an interference rejection capability of a controller, a nonlinear PID controller is designed. A direct error integration manner of a conventional PID controller is changed by the nonlinear PID controller using a nonlinear function that amplifies small errors and saturates large errors for integration. The hysteresis nonlinearity of the piezoelectric ceramic actuator can be well compensated by the established hysteresis inverse compensation method. In addition, the established nonlinear proportional integral derivative (PID) inverse compensation control method not only reduces an oscillation caused by integration but also improves overall control accuracy of the controller.

The patent with a publication number CN114253138A, filed on Dec. 16, 2021, discloses a compensation control method and system for a nano positioning platform based on a dynamic delay Prandtl-Ishlinskii (PI) model, belonging to the field of control engineering. The method includes: under a plurality of frequencies, respectively collecting output displacements generated by a piezoelectric actuator in the nanometer positioning platform under different driving voltages, and generating a hysteresis curve of the driving voltage and the output displacement at each frequency; establishing a dynamic delay PI model including a delayed play operator, where a rising delay coefficient and a falling delay coefficient are introduced into the driving voltage term of a delayed play operator; adjusting the rising delay coefficient and the falling delay coefficient until a fitting degree between the dynamic delay PI model and each of the hysteresis curves is less than a preset threshold; and resolving an inverse model of an optimal dynamic delay PI model, and performing compensation control on the nano positioning platform based on the inverse model. Asymmetric and rate-dependent hysteresis nonlinearities of the piezoelectric actuator are compensated to achieve precise control of the nano positioning platform.

The foregoing technology has poor robustness when processing the complex nonlinearity and parameter mutation of the piezoelectric system, and a poor ability to eliminate steady-state errors when the piezoelectric system is independently used.

### SUMMARY

To resolve problems that in the conventional technology that robustness is poor when complex nonlinearity and parameter mutation of a piezoelectric system are processed, and an ability to eliminate steady-state errors is weak when the piezoelectric system is independently used, the present disclosure discloses a nonlinear compensation control method for a piezoelectric system based on model reference adaptive control-proportional integral derivative (MRAC-PID) composite control.

The technical solutions adopted by the present disclosure to resolve the above technical problems are as follows: The nonlinear compensation control method includes following steps:
step 1, establishing a dynamics model of the piezoelectric system; and
step 2, designing an MRAC-PID algorithm.

Further, a process of establishing the dynamics model of the piezoelectric system in the step 1 is as follows:
enabling a mechanical structure of the piezoelectric system to be equivalent to a mass-spring-damper system, setting a mass as m, a spring stiffness as k, a damping coefficient as b, and applying an external force F to a piezoelectric actuator to generate a displacement x;
according to a Newton's second law, obtaining a dynamics equation of the piezoelectric system according to formula (1):

m\ddot{x}+b\dot{x}+kx=F (1)
performing a Laplace transform on the formula (1), to obtain a transfer function Gₘ(s) of the mechanical structure according to formula (2):

$${G}_{m} ( s ) = \frac{X ( s )}{F ( s )} = \frac{1}{m {s}^{2} + b s + k} , where \qquad ( 2 )$$

in the formula (2), S indicates a complex variable in the Laplace transform, X(s) indicates an expression of a displacement x(t) in time domain after the Laplace transform is performed in frequency domain, and F(s) indicates an expression of an external force F(t) in the time domain after the Laplace transform is performed in the frequency domain.

Further, the step 2 of designing the MRAC-PID algorithm includes following steps:
step 201, establishing a reference model for a second-order system;
step 202, defining an error;
step 203, designing a PID controller;
step 204, designing an MRAC adaptive control law; and
step 205, deriving an adaptive law based on a Lyapunov stability theory.

Further, the step 201 includes:
obtaining a dynamics equation of the reference model according to formula (3):

mₘ\ddot{x}ₘ(t)+bₘ\dot{x}ₘ(t)+kₘxₘ(t)=αₘr(t) (3), where
in the formula (3), mₘ indicates an equivalent mass of the reference model, bₘ indicates a damping coefficient of the reference model, kₘ indicates a spring stiffness of the reference model, xₘ(t) indicates a displacement output of the reference model, r(t) indicates a reference input, and α(m) indicates a piezoelectric conversion coefficient of the reference model.

Further, the step 202 of defining the error includes:
defining the error e(t) as a difference between an actual system output x(t) and a reference model output xₘ(t):

e(t)=x(t)−xₘ(t) (4;
taking first and second derivatives of the error:

ė(t)=\dot{x}(t)−\dot{x}ₘ(t) (5), and

ë(t)=\ddot{x}(t)−\ddot{x}ₘ(t) (6).

Further, the step 203 of designing the PID controller includes: calculating, by the PID controller based on the e(t), a control quantity u_{PID}(t), with an expression of the control quantity according to formula (7):

$${U}_{PID} ( t ) = {K}_{p} e ( t ) + {K}_{i} {\int }_{0}^{t} e ( τ ) d τ + {K}_{d} \dot{e} ( t ) , \qquad ( 7 )$$

where
in the formula (7), Kₚ indicates a proportional coefficient, Kᵢ indicates an integral coefficient, and K_{d} indicates a differential coefficient.

Further, the step 204 of designing the MRAC adaptive law includes the following steps:
introducing an adaptive control law to integrate an adaptation mechanism according to formula (8):

u(t)=θ₁(t)u_{PID}(t)+θ₂(t)x(t)+θ₃(t)\dot{x}(t) (8), where
in the formula (8), θ₁(t), θ₂(t), and θ₃ (t) indicate adaptive parameters.

Further, the step 205 of deriving the adaptive law based on a Lyapunov stability theory includes:
selecting a Lyapunov function V(t) to ensure stability of the piezoelectric system according to formula (9):

$$V ( t ) = \frac{1}{2} {e}^{2} ( t ) + \frac{1}{2} {\dot{e}}^{2} ( t ) + \frac{1}{{2}_{{γ}_{1}}} {\tilde{θ}}_{1}^{2} ( t ) + \frac{1}{{2}_{{γ}_{2}}} {\tilde{θ}}_{2}^{2} ( t ) + \frac{1}{{2}_{{γ}_{3}}} {\tilde{θ}}_{3}^{2} ( t ) , \qquad ( 9 )$$

where
in the formula (9),

$${\tilde{θ}}_{i} ( t ) = {θ}_{i} ( t ) - {θ}_{i}^{*} ( i = 1 , 2 , 3 )$$

indicates an estimation error of an adaptive parameter,

$${θ}_{i}^{*}$$

indicates an optimal parameter value, and γ₁, γ₂, and γ₃ indicate positive adaptive gains;
taking a first derivative of V(t):

$$\dot{V} ( t ) = e ( t ) \dot{e} ( t ) + \dot{e} ( t ) \ddot{e} ( t ) + \frac{1}{{γ}_{1}} {\tilde{θ}}_{1} ( t ) {{θ}^{\dot{\sim}}}_{1} ( t ) + \frac{1}{{γ}_{2}} {\tilde{θ}}_{2} ( t ) {{θ}^{\dot{˜}}}_{2} ( t ) + \frac{1}{{γ}_{3}} {\tilde{θ}}_{3} ( t ) {{θ}^{\dot{˜}}}_{3} ( t ) , \qquad ( 10 )$$

substituting an equation of an actual piezoelectric system and an equation of the reference model into an expression of ë(t), and then into \dot{V}(t) making \dot{V}(t)≤0 by rearranging and selecting the adaptive law, and deriving the adaptive law:

\dot{θ}₁(t)=γ₁u_{PID}(t)ė(t) (11),

\dot{θ}₂(t)=γ₂x(t)ė(t) (12), and

\dot{θ}₃(t)=γ₃\dot{x}(t)ė(t) (13).

The present disclosure has following beneficial effects:
1. The present disclosure enhances control accuracy: The adaptive capability of MRAC is integrated with the precise regulation characteristics of PID, effectively compensating for the nonlinearities of the piezoelectric system, and significantly improving control precision. In comparison with the traditional PID control or MRAC alone, steady-state errors can be greatly reduced, enabling more precise control of the piezoelectric system.
2. The present disclosure improves the interference rejection capability: Fast response of the PID controller is combined with adaptive adjustment of MRAC, allowing a piezoelectric actuator to react promptly and adjust a control signal in the face of external interferences. In the presence of interferences such as mechanical vibrations and temperature variations, the stable operation of the piezoelectric system can be maintained, effectively suppressing the impact of interferences on the piezoelectric system and enhancing robustness of the piezoelectric system.
3. The present disclosure accelerates a convergence speed: A parameter adjustment process is optimized by the MRAC-PID composite control structure, enabling a system output to converge to a reference model output more rapidly in comparison with the conventional control method. During system startup or operational state transitions, the piezoelectric system reaches a stable state more quickly, improving dynamic response performance of the piezoelectric system.
4. The present disclosure achieves strong adaptability: The present disclosure allows for flexible adjustment of MRAC and PID parameters based on the characteristics of different piezoelectric systems and application scenarios, providing extensive applicability. Excellent control performance can be achieved in high-precision astronomical observation or the industrial laser processing field.

### BRIEF DESCRIPTION OF THE DRAWINGS

FIG. 1 is a schematic diagram of a dynamics equivalent model of a piezoelectric system;

FIG. 2 is a control block diagram of a MRAC-PID (model reference adaptive control-proportional integral derivative) compensation method; and

FIG. 3 is a flowchart of a MRAC-PID algorithm.

### DETAILED DESCRIPTION OF THE EMBODIMENTS

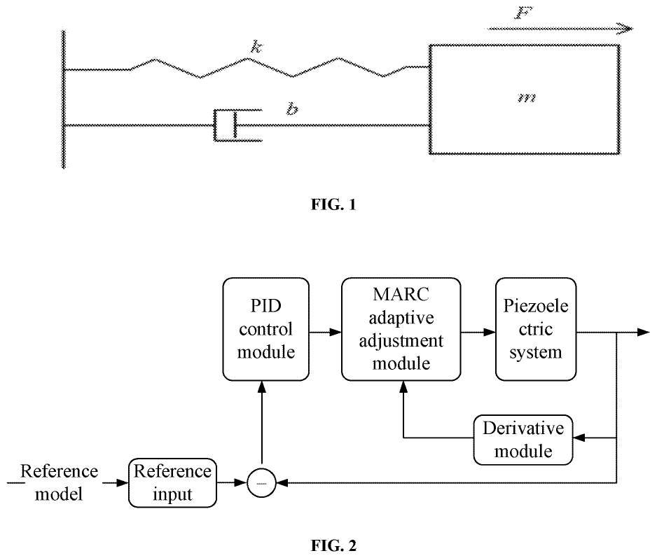

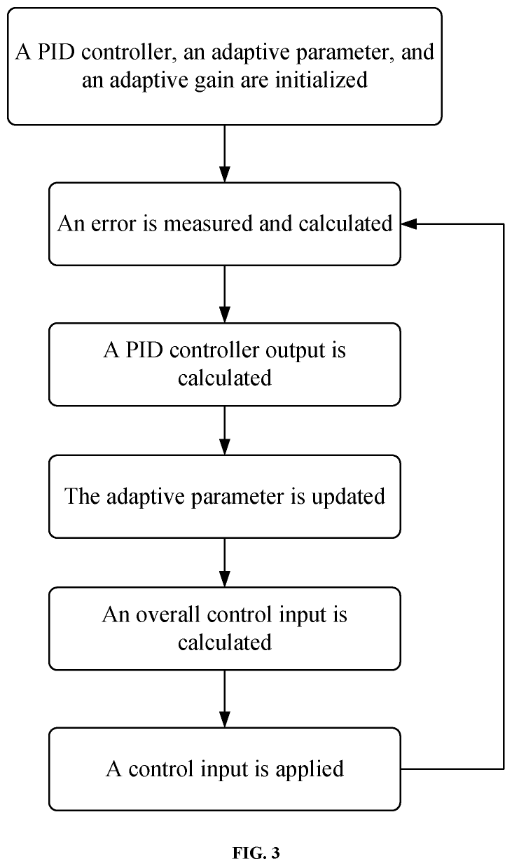

Embodiment 1: As shown in FIG. 1 to FIG. 3, a nonlinear compensation control method for a piezoelectric system based on model reference adaptive control-proportional integral derivative (MRAC-PID) composite control includes following steps.

In step 1, a dynamics model of the piezoelectric system is established, and a specific process is as follows:
a mechanical structure of the piezoelectric system is enabled to be equivalent to a mass-spring-damper system, a mass is set as M, a spring stiffness is set as k, a damping coefficient is set as b, and an external force F is applied to a piezoelectric actuator to generate a displacement x;
according to a Newton's second law, a dynamics equation of the piezoelectric system is obtained according to formula (1):

m\ddot{x}+b\dot{x}+kx=F (1);
a Laplace transform is applied to the formula (1), to obtain a transfer function Gₘ(s) of the mechanical structure according to formula (2):

$${G}_{m} ( s ) = \frac{X ( s )}{F ( s )} = \frac{1}{m {s}^{2} + b s + k} , \qquad ( 2 )$$

where
in the formula (2), s indicates a complex variable in the Laplace transform, X(s) indicates an expression of a displacement x(t) in time domain after the Laplace transform is performed in frequency domain, and F(s) indicates an expression of an external force F(t) in the time domain after the Laplace transform is performed in the frequency domain.

In step 2, a MRAC-PID algorithm is designed, and following steps are included.

In step 201, a reference model is established for a second-order system.
a dynamics equation of the reference model is obtained according to formula (3):

mₘ\ddot{x}ₘ(t)+bₘ\dot{x}ₘ(t)+kₘxₘ(t)=αₘr(t) (3), where
in the formula (3), m indicates an equivalent mass of the reference model, bₘ indicates a damping coefficient of the reference model, kₘ indicates a spring stiffness of the reference model, xₘ(t) indicates a displacement output of the reference model, r(t) indicates a reference input, and α(in) indicates a piezoelectric conversion coefficient of the reference model.

In step 202, an error is defined.

The error e(t) is defined as a difference between an actual system output x(t) and a reference model output xₘ(t):

e(t)=x(t)−xₘ(t) (4).

First and second derivatives of the error are taken:

ė(t)=\dot{x}(t)−\dot{x}ₘ(t) (5), and

ë(t)=\ddot{x}(t)−\ddot{x}ₘ(t) (6).

In step 203, a PID controller is designed.

A control quantity u_{PID}(t) is calculated by the PID controller based on the error e(t), with an expression of the control quantity according to formula (7):

$${u}_{PID} ( t ) = {K}_{p} e ( t ) + {K}_{i} {\int }_{0}^{t} e ( τ ) d τ + {K}_{d} \dot{e} ( t ) , \qquad ( 7 )$$

where
in the formula (7), Kₚ indicates a proportional coefficient, Kᵢ indicates an integral coefficient, and K_{d} indicates a differential coefficient.

In step 204, an MRAC adaptive control law is designed.

An adaptive control law is introduced to integrate an adaptation mechanism according to formula (8):

u(t)=θ₁(t)u_{PID}(t)+θ₂(t)x(t)+θ₃(t)\dot{x}(t) (8), where
in the formula (8), θ₁(t), θ₂(t), and θ₃(t) indicate adaptive parameters.

In step 205, an adaptive law is derived based on a Lyapunov stability theory.

A Lyapunov function V(t) is selected to ensure stability of the piezoelectric system according to formula (9):

$$V ( t ) = \frac{1}{2} {e}^{2} ( t ) + \frac{1}{2} {\dot{e}}^{2} ( t ) + \frac{1}{{2}_{{γ}_{1}}} {\tilde{θ}}_{1}^{2} ( t ) + \frac{1}{{2}_{{γ}_{2}}} {\tilde{θ}}_{2}^{2} ( t ) + \frac{1}{{2}_{{γ}_{3}}} {\tilde{θ}}_{3}^{2} ( t ) , \qquad ( 9 )$$

where
in the formula (9),

$${\tilde{θ}}_{i} ( t ) = {θ}_{i} ( t ) - {θ}_{i}^{*} ( i = 1 , 2 , 3 )$$

indicates an estimation error of an adaptive parameter,

$${θ}_{i}^{*}$$

indicates an optimal parameter value, and γ₁, γ₂, and γ₃ indicate positive adaptive gains.

A first derivative of V(t) is taken:

$$\dot{V} ( t ) = e ( t ) \dot{e} ( t ) + \dot{e} ( t ) \ddot{e} ( t ) + \frac{1}{{γ}_{1}} {\tilde{θ}}_{1} ( t ) {{θ}^{\dot{\sim}}}_{1} ( t ) + \frac{1}{{γ}_{2}} {\tilde{θ}}_{2} ( t ) {{θ}^{\dot{˜}}}_{2} ( t ) + \frac{1}{{γ}_{3}} {\tilde{θ}}_{3} ( t ) {{θ}^{\dot{˜}}}_{3} ( t ) . \qquad ( 10 )$$

An equation of an actual piezoelectric system and an equation of the reference model are substituted into an expression of ë(t), and then into \dot{V}(t), making \dot{V}(t)≤0 by rearranging and selecting the adaptive law, and the adaptive law is derived:

\dot{θ}₁(t)=γ₁u_{PID}(t)ė(t) (11),

\dot{θ}₂(t)=γ₂x(t)ė(t) (12), and

\dot{θ}₃(t)=γ₃\dot{x}(t)ė(t) (13).

The above embodiments are only preferred ones of the present disclosure, and are not intended to limit the present disclosure in any form. Although the present disclosure has been disclosed by the foregoing embodiments, these embodiments are not intended to limit the present disclosure. Any person skilled in the art may make some changes or modifications to implement equivalent embodiments with equivalent changes by using the technical contents disclosed above without departing from the scope of the technical solution of the present disclosure. Any simple modification, equivalent change and modification made to the foregoing embodiments according to the technical essence of the present disclosure without departing from the content of the technical solution of the present disclosure shall fall within the scope of the technical solution of the present disclosure.

What is claimed is:

1. A nonlinear compensation control method for a piezoelectric system based on model reference adaptive control-proportional integral derivative (MRAC-PID) composite control, comprising following steps:
step 1, establishing a dynamics model of the piezoelectric system; and
step 2, designing an MRAC-PID algorithm.

2. The nonlinear compensation control method for a piezoelectric system based on MRAC-PID composite control according to claim 1, wherein a process of establishing the dynamics model of the piezoelectric system in the step 1 is as follows:
enabling a mechanical structure of the piezoelectric system to be equivalent to a mass-spring-damper system, setting a mass as m, a spring stiffness as k, a damping coefficient as b, and applying an external force F to a piezoelectric actuator to generate a displacement x;
according to a Newton's second law, obtaining a dynamics equation of the piezoelectric system according to formula (1):
m\ddot{x}+b\dot{x}+kx=F (1),
performing a Laplace transform on the formula (1), to obtain a transfer function Gₘ(s) of the mechanical structure according to formula (2):
$${G}_{m} ( s ) = \frac{X ( s )}{F ( s )} = \frac{1}{m {s}^{2} + b s + k} , \qquad ( 2 )$$
wherein
in the formula (2), S indicates a complex variable in the Laplace transform, X(s) indicates an expression of a displacement x(t) in time domain after the Laplace transform is performed in frequency domain, and F(s) indicates an expression of an external force F(t) in the time domain after the Laplace transform is performed in the frequency domain.

3. The nonlinear compensation control method for a piezoelectric system based on MRAC-PID composite control according to claim 1, wherein the step 2 of designing the MRAC-PID algorithm comprises following steps:
step 201, establishing a reference model for a second-order system;
step 202, defining an error;
step 203, designing a PID controller;
step 204, designing an MRAC adaptive control law; and
step 205, deriving an adaptive law based on a Lyapunov stability theory.

4. The nonlinear compensation control method for a piezoelectric system based on MRAC-PID composite control according to claim 3, wherein the step 201 comprises following step:
obtaining a dynamics equation of the reference model according to formula (3):
mₘ\ddot{x}ₘ(t)+bₘ\dot{x}ₘ(t)+kₘxₘ(t)=αₘr(t) (3), where
in the formula (3), mₘ indicates an equivalent mass of the reference model, bₘ indicates a damping coefficient of the reference model, kₘ indicates a spring stiffness of the reference model, xₘ(t) indicates a displacement output of the reference model, r(t) indicates a reference input, and α(m) indicates a piezoelectric conversion coefficient of the reference model.

5. The nonlinear compensation control method for a piezoelectric system based on MRAC-PID composite control according to claim 3, wherein the step 202 of defining the error comprises following steps:
defining the error e(t) as a difference between an actual system output x(t) and a reference model output xₘ(t):
e(t)=x(t)−xₘ(t) (4); and
taking first and second derivatives of the error:
ė(t)=\dot{x}(t)−\dot{x}ₘ(t) (5), and
ë(t)=\ddot{x}(t)−\ddot{x}ₘ(t) (6).

6. The nonlinear compensation control method for a piezoelectric system based on MRAC-PID composite control according to claim 3, wherein the step 203 of designing the PID controller comprises following steps:
calculating, by the PID controller based on the error e(t), a control quantity u_{PID}(t), with an expression of the control quantity u_{PID}(t) according to formula (7):
$${u}_{PID} ( t ) = {K}_{p} e ( t ) + {K}_{i} {\int }_{0}^{t} e ( τ ) d τ + {K}_{d} \dot{e} ( t ) , \qquad ( 7 )$$
wherein
in the formula (7), Kₚ indicates a proportional coefficient, Kᵢ indicates an integral coefficient, and K_{d} indicates a differential coefficient.

7. The nonlinear compensation control method for a piezoelectric system based on MRAC-PID composite control according to claim 3, wherein the step 204 of designing the MRAC adaptive control law comprises following step:
introducing an adaptive control law to integrate an adaptation mechanism according to formula (8):
u(t)=θ₁(t)u_{PID}(t)+θ₂(t)x(t)+θ₃(t)\dot{x}(t) (8), where
in the formula (8), θ₁(t), θ₂(t), and θ₃(t) indicate adaptive parameters.

8. The nonlinear compensation control method for a piezoelectric system based on MRAC-PID composite control according to claim 5, wherein the step 205 of deriving the adaptive law based on a Lyapunov stability theory comprises following steps:
selecting a Lyapunov function V(t) to ensure stability of the piezoelectric system according to formula (9):
$$V ( t ) = \frac{1}{2} {e}^{2} ( t ) + \frac{1}{2} {\dot{e}}^{2} ( t ) + \frac{1}{{2}_{{γ}_{1}}} {\tilde{θ}}_{1}^{2} ( t ) + \frac{1}{{2}_{{γ}_{2}}} {\tilde{θ}}_{2}^{2} ( t ) + \frac{1}{{2}_{{γ}_{3}}} {\tilde{θ}}_{3}^{2} ( t ) , \qquad ( 9 )$$
wherein
in the formula (9),
$${\tilde{θ}}_{i} ( t ) = {θ}_{i} ( t ) - {θ}_{i}^{*} ( i = 1 , 2 , 3 )$$
indicates an estimation error of an adaptive parameter,
$${θ}_{i}^{*}$$
indicates an optimal parameter value, and γ₁, γ₂, and γ₃ indicate positive adaptive gains;
taking a first derivative of V(t):
$$\dot{V} ( t ) = e ( t ) \dot{e} ( t ) + \dot{e} ( t ) \ddot{e} ( t ) + \frac{1}{{γ}_{1}} {\tilde{θ}}_{1} ( t ) {{θ}^{\dot{\sim}}}_{1} ( t ) + \frac{1}{{γ}_{2}} {\tilde{θ}}_{2} ( t ) {{θ}^{\dot{˜}}}_{2} ( t ) + \frac{1}{{γ}_{3}} {\tilde{θ}}_{3} ( t ) {{θ}^{\dot{˜}}}_{3} ( t ) ; \qquad ( 10 )$$
substituting an equation of an actual piezoelectric system and an equation of the reference model into an expression of ë(t), and then into \dot{V}(t), making \dot{V}(t)≤0 by rearranging and selecting the adaptive law, and deriving the adaptive law:
\dot{θ}₁(t)=γ₁u_{PID}(t)ė(t) (11),
\dot{θ}₂(t)=γ₂x(t)ė(t) (12), and
\dot{θ}₃(t)=γ₃\dot{x}(t)ė(t) (13).
